(19) United States
(12) Patent Application Publication
(10) Pub. No.: US 2010/0324969 A1
(43) Pub. Date: Dec. 23, 2010

(54) SYSTEM AND METHOD FOR IMPLEMENTING AN END OF ROUND IN A MULTIPLE ROUND AUCTION

(76) Inventor: Brad Miller, Medfield, MA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/489,032

(22) Filed: Jun. 22, 2009

(51) Int. Cl. G06Q 30/00; G06Q 10/00

(52) U.S. Cl. 705/10; 705/26

(57) ABSTRACT

A system and method for implementing End-Of-Round (EOR) calculations in computer implemented multiple round auctions. The EOR process allows for the adjustment of price, quantity, and other parameters, and also adjusts bids as necessary in accordance with the auction rules, parameter values, and constraints. Feasible starting points for the EOR process can be determined based on the post-EOR adjusted bids following the previous round, or based on bids submitted in the round just ended. Bid deviations based on switching and/or reductions in eligibility can be analyzed. Bid requests can be evaluated and granted based on auction rules, parameter values, and/or constraints. Bids can be rolled-back to realize a feasible solution. The EOR process can iteratively loop through the collection of bid deviations until all the bid deviations have been considered, or until an established time limit is reached.

### BACKGROUND

This invention generally relates to computer implemented auction systems. More particularly, this invention relates to the algorithms used to determine the results of bidding at the end of a round in a multiple round auction. In general, a computer implemented auction will be governed by proscribed bidding rules. The bidding rules can provide procedural guidelines for auction related activities such as who is eligible to bid in an auction event, what the starting prices are, and how much of the auctioneer's quantity (e.g., a seller's supply) will be available for the bidders to bid on. The bidding rules can further describe how and when bids are entered, how and when bidding rounds occur, the conditions applied at the end of the bidding round, and when the auction has closed. The end-of-round (EOR) rules are of particular importance because an appropriate relationship between prices and quantities can be maintained. Accordingly, there is a need for a systematic approach to the design and implementation of the end-of-round rules in a multiple round auction.

### SUMMARY

In general, in an aspect, the invention provides a system for conducting multi-round auctions, including remote computer stations connected to a network and configured to receive bid information from bidders in successive rounds, a Web server component to receive and store the bid information from the remote computer stations, receive and store auction parameters, and including application software configured to evaluate the bid information at the end of each of the successive rounds, such that evaluating the bid information includes evaluating the received bid information to determine if any of the bidders changed their bid information in the current round just ended as compared to the previous round, rolling back the bid information received from at least one bidder if their bid information changed between the current and the previous rounds, such that the rolled-back bid information equals at least a part of the bid information provided by the bidder in the previous round, calculating a collective bid information as a function of the current bid information received from bidders whose individual bid information was not rolled back and the rolled-backed bid information from the bidders whose individual bids information was rolled back, determining whether the collective bid information satisfies auction parameters, and outputting the collective bid information.

Implementations of the invention may include one or more of the following features. The bid information and the auction parameters can include price and quantity information. Evaluating bid information can include increasing or decreasing the prices in the auction parameters if the quantities in the collective bid information are greater or less than the quantity in the auction parameters. The auction parameters can include demand parameters. The auction parameters can include supply parameters. Rolling back the bid information can include rolling back only bid information that changed based on eligibility reductions. Rolling back the bid information can include rolling back only bid information that changed based on switches. Rolling back the bid information can include rolling back bid information that changed based on eligibility reductions, and then rolling back bid information that changed based on switches. Rolling back the bid information can include rolling back bid information that changed based on switches, and then rolling back bid information that changed based on eligibility reduction.

In general, in an another aspect, the invention provides a computer implemented multi-round auction system to provide feasible solutions to satisfy supply, demand and price constraints, including a storage device, a processor programmed to receive bids from bidders in a series of sequential rounds, compare the bids received in a current round with an auction parameter to determine if a constraint is satisfied, if the constraint is not satisfied, then determine which bids changed between the current round and the previous round, and iteratively roll back changed bids until the constraint is satisfied, and store the bids on the storage device.

Implementations of the invention may include one or more of the following features. The bids can include price information. Rolling back the changed bids can include decreasing the value of the price information in the bids. Rolling back the changed bids can include increasing the value of the price information in the bids. Rolling back the changed bids can include setting a value of the bid received from a bidder in the current round to be equal to the value of the bid received from the bidder in the previous round. The bid received from a bidder in the previous round can include a first value, and the bid received from the bidder in the current round can include a second value, and rolling back the changed bids can include setting the bid received from the bidder in the current round to a third value, such that the third value is within a range of values between the first and second values.

In general, in another aspect, the invention provides a computer-readable medium having computer-executable instructions for managing multi-round auctions over a network, including storing auction parameters, storing information associated with quantity blocks, setting a first price value for each of the blocks, receiving first bids from bidders over the network, such that the first bids include price and quantity information, determining a second price value as a function of the first bids and at least one auction parameter, storing the second price value for each block, receiving subsequent bids from the bidders over the network, such that the subsequent bids include price and quantity information, rolling back the price information in the subsequent bids submitted by at least one bidder to the value of the price information in the bidder's first bid, determining if the multi-round auction is complete, and outputting an auction result.

Implementations of the invention may include one or more of the following features. Rolling back the quantity information in the subsequent bids submitted by at least one bidder to the value of the quantity information in the bidder's first bid. Managing multi-round auctions over a network can include rolling back the price information in the subsequent bids submitted by at least one bidder to a value between the price information in the bidder's first and subsequent bids. Rolling back the quantity information in the subsequent bids submitted by at least one bidder to a value between the quantity information in the bidder's first and subsequent bids. Storing a first price information associated with each block in a first subset of the plurality of blocks, and storing a second price information associated with each block in a second subset of the plurality of blocks. Free eligibility blocks can be stored.

In accordance with implementations of the invention, one or more of the following capabilities may be provided. Auction rules and constraints can be implemented across a network. Multiple round auctions can be managed from local and/or remote servers. Bids can be received over a local area network and/or wide area network and/or the Internet. Feasible solutions and acceptable bids can be determined for each round. Multiple product types and associated offerings can be bundled into blocks. Bidding can be evaluated on a block by block basis. Single and multiple price levels can be established. The price/quantity relationships can be maintained. Bids submitted in a round that cause under- or over-subscription for one or more products can be adjusted. Priority can be given to either switched bid quantities or eligibility reduction bid quantities. Rollbacks can be based solely on eligibility reduction. Free eligibility blocks can be determined. Auction managers can modify or override rules and constraints during an auction. In general, auction rules and constraints can be stored and executed via programmable computers, or via human intervention. In an embodiment, multiple round auctions can be executed automatically over a wide area through the use of computers and associated networking structures. For example, an auctioneer, bidders, and an auction manager can be located in different locations and information can flow over the network.

These and other capabilities of the invention, along with the invention itself, will be more fully understood after a review of the following figures, detailed description, and claims.

### BRIEF DESCRIPTION OF THE FIGURES

FIG. 1 is an exemplary computer implemented auction network.

FIG. 2 is a flow chart of an exemplary end-of-round process.

### DETAILED DESCRIPTION OF PREFERRED EMBODIMENTS

Embodiments of the invention provide techniques for performing End-Of-Round (EOR) calculations in computer implemented multiple round auctions. The EOR process allows for the adjustment of price, quantity, and other parameters, and also adjusts bids as necessary in accordance with the auction rules, parameter values, and constraints. The EOR process can use the post-EOR results of round r-1 as a feasible starting point when determining the EOR results at the end of the subsequent round r. Each bid in the round r by a bidder which deviates from the bidder's bid in round r-1 can be considered on a quantity block by quantity block basis. Bid deviations based on switching and/or reduction in eligibility can be analyzed. If granting the bidders' requests (i.e., allowing deviations in the bids) does not violate a rule and/or constraint, then the requests can be granted. If granting the bidders' requests would violate a rule and/or constraint, then the EOR process can roll back individual blocks to realize a feasible solution. Due to the interdependencies of bid deviations, the EOR process can iteratively loop through the collection of bid deviations until all the bid deviations have been considered, or until an established time limit is reached. This EOR process is exemplary, however, and not limiting of the invention as other implementations in accordance with the disclosure are possible.

In general, computer implemented auction systems can be installed on computer systems via a computer-readable medium containing computer-executable code. Computer-readable medium can be broadly defined as any kind of computer memory such as floppy disks, conventional hard disks, CD-ROMS, Flash ROMS, nonvolatile ROM, and RAM. Further, these computer systems are typically connected to a network (e.g., LAN, WAN, the Internet) and can be configured to receive computer-executable code through the network. An auction manager and auction participants can exchange bid information over the network via computers and servers.

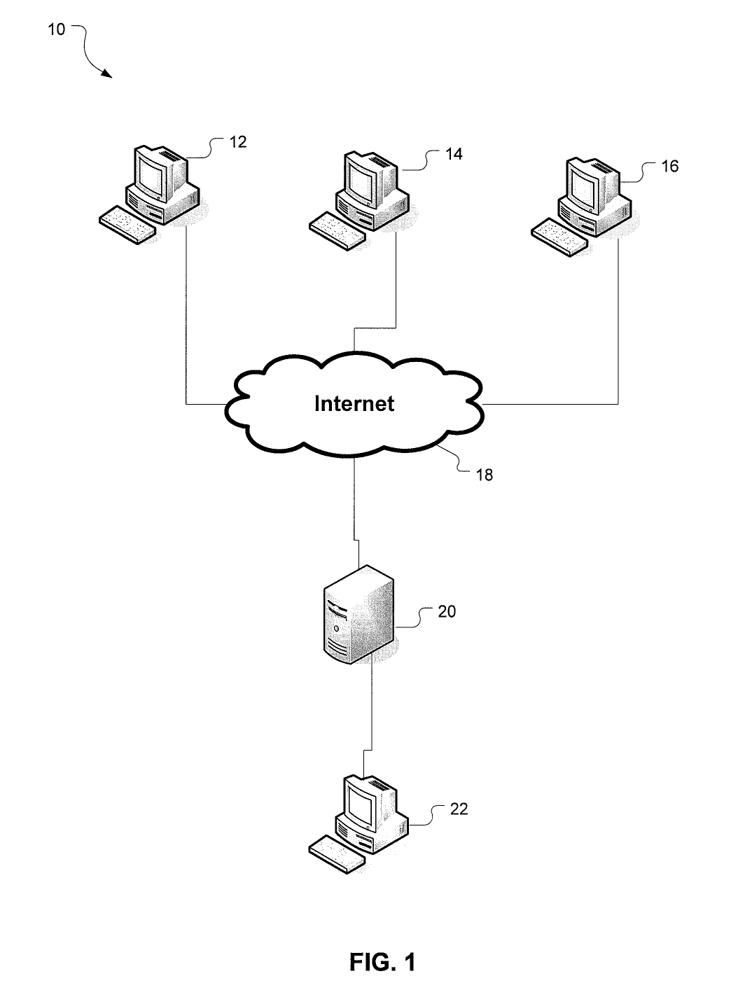

Referring to FIG. 1, an exemplary auction network 10 is shown. The network includes remote computer stations 12, 14, 16, which are configured on networks such as the Internet 18, an application server 20, and an administrator computer workstation 22. In general, the computer stations 12, 14, 16, 22 can include a processor, memory, display device, and operating software such as Microsoft Windows® or Linux. Other networked equipment such as fax machines, scanners and printers may be used. The computers 12, 14, 16, 20, 22 are configured to display and receive information as known in the art. The network 10 can be configured to perform cohesively such that the individual components (i.e., processors, memory, software) on each of computer stations and servers can coordinate processing, storage and display tasks as known in the art.

In general, the auctions are conducted to a global market and the computer network 10 is configured to utilize the Internet. The server 20 can be based on Microsoft applications (e.g., Windows Server), or other programs such as Unix. In general, the auction system resides on the server 20, however, in an embodiment, elements of the auction system can also reside on the computer stations 12, 14, 16, 22. As described above, the computer network 10 is configured to receive, store and disseminate auction information from the auctioneer, bidders and auction manager. For example, multiple round auction elements such as rules and constraints, schedule of rounds, end of round calculations, bid information can be stored in the network 10. Bid information and auction rules can be stored and used as input by auction managers or auction manager software to trigger auction events such as ending the auction. The network 10 can be configured to interact with existing business applications such as email and print servers for data collection and dissemination. For example, bid information can be received and transmitted via email. Auction rules and constraints can be emailed, posted to a Web site and/or sent to print servers to produce hard copies. An auction manager can communicate to bidders via instant messaging application, voice over IP, or the Web browser.

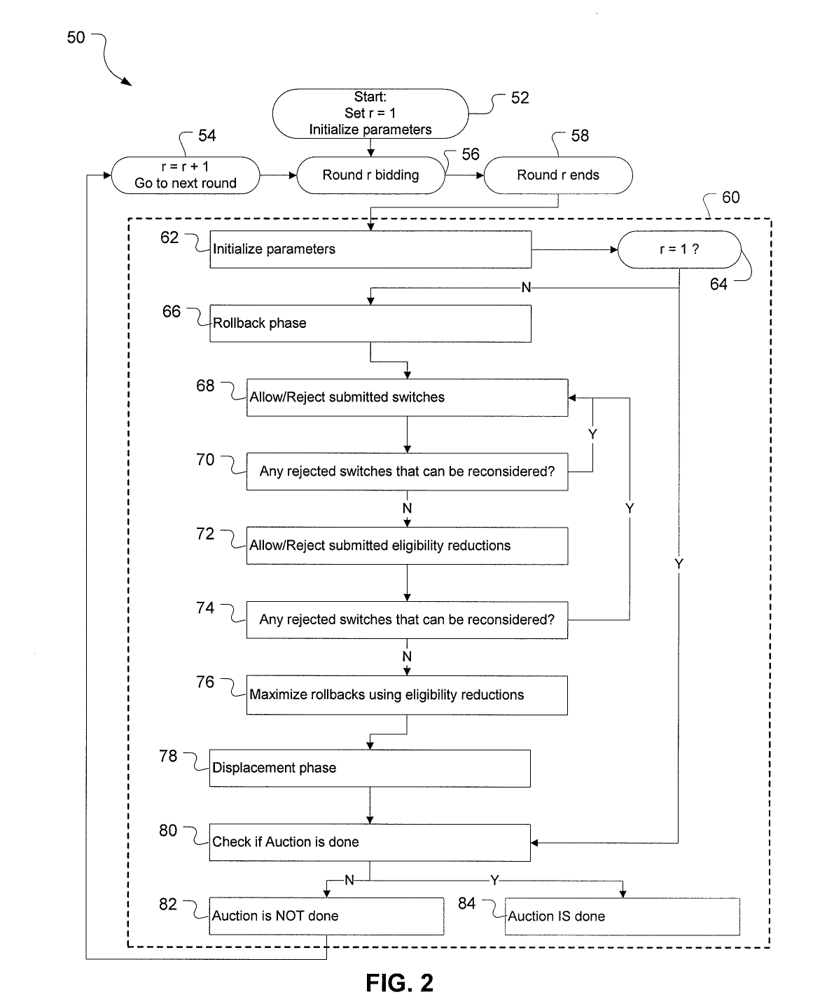

In operation, referring to FIG. 2, with further reference to FIG. 1, a process 50 for implementing end-of-round constraints using the system 10 includes the stages shown. The process 50, however, is exemplary only and not limiting. The process 50 may be altered, e.g., by having stages added, removed, or rearranged.

In general, the EOR process 50 can be configured to consider one or more bids that were submitted in a bidding round r of a multiple round auction, and then possibly make adjustments to those bids in order to satisfy established constraints and/or auction rules. The process 50 can be configured to report the adjusted bids back to the bidders through the system 10 before the next round begins.

The EOR process 50 can be used in wide array of multiple round auctions. Stages 52, 54, 56, 58 generally describe the elements of a generic multiple round auction such as a start element 52, a incremental round count element 54, a bidding element 56, and end of bidding element 58. For example, it can be used in two phase auctions as described in co-pending U.S. patent application Ser. No. 12/288,029, filed on Oct. 16, 2008 and titled “2-Phase Auction Design and Implementation Methods.” The EOR process 50 can also be implemented in auctions that do not include a clock phase, nor sealed bid components. The EOR process 50 can be used in forward auctions (i.e., wherein the auctioneer is the seller, and the bidders are buyers), or a reverse auction (e.g., a procurement auction, wherein the auctioneer is a buyer and the bidders are sellers). The EOR process 50 can be used in ascending-price auctions (i.e., wherein prices tend to increase round by round), or in descending-price auctions (i.e., wherein prices tend to decrease round by round). As an example, and not a limitation, the EOR process 50 described herein is directed to a forward ascending-price auction for ease of understanding only. The EOR process 50 can be applied to reverse auctions and to descending-price auctions as well.

In general, the EOR process 50 can process bids at the end of each round r in a multiple round auction. At stage 58, when a round r ends, a series of data verification and data transformation steps 60 can be performed in the server 20.

At stage 62, a series of auction parameters are initialized. In the context of a computer implemented auction system, parameters can be initialized by being stored in memory. In general, auction parameters such as supply, demand and prices can be initialized before an auction and then reset at the end of each round r. For example, the supply, demand and price parameters can be specified prior to the auction, or can be based on bids that were submitted at stage 56 in the round r that just ended. In a forward auction embodiment, the supply parameters can be provided by an auctioneer (e.g., minimum supply quantity of each product, the maximum supply quantity of each product, aggregations of the products, for example grouped by product types, contract periods, and corresponding intersections). In general, there can be minimum and maximum supply constraints for each product type, contract periods, as well as aggregations such as, for example, across a given product type, and/or across the contract periods.

In an embodiment, demand parameters can include eligibility (e.g., the maximum quantity that a bidder can bid in any round across all of the products). In an example, eligibility generally cannot be increased in an auction, but it can be decreased based on submitted bids. Other demand parameters can include a contract period maximum. In general, a contract period maximum is a constraint on the maximum quantity that a bidder can bid across the products for the given contract period. For example, each bidder can have a contract period bid limit of ten blocks for a particular contract period, which means that for any one round, a bidder cannot bid more than ten blocks across the product types for that contract period.

As examples, and not limitations, initialized parameters can include initial starting prices and differential pricing parameters across product types and/or contract periods. Other kinds of constraints and parameters can be used based on the nature of the auction and the corresponding products.

Initializing the parameters at stage 62 also includes determining an initial set of feasible and acceptable bids. For example, the feasible or acceptable bids could be the acceptable bids from the prior round (r-1). New bids submitted in round r can be compared to these previous bids to determine if changes were made. The changes can be evaluated one at a time to determine whether or not each individual change is acceptable in view of the established parameters. If a particular changed bid is acceptable (i.e., does not violate an established parameter), it can be accepted for the next round. The remaining changed bids can be similarly evaluated. The changed bids can be analyzed according to a rule or an objective or in different orders. For example, the bids can be randomized by bidder, or randomized by quantity unit (i.e., block). Other program loops can also be used to evaluate each of the changed bids.

In an embodiment, the initial bids to consider are the bids just submitted (i.e., without comparison to the previous round). That is, the bids submitted in a round are accepted as the initial starting set of bids.

In general, in an embodiment, initializing the parameters at stage 62 can establish two vectors: an increased-bid vector and a decreased-bid vector, or an increased-quantity vector and a decreased-quantity vector. These vectors can represent the changes the bidders submitted in the round just ended as compared to the prior round. It is those changed bids that can be evaluated to determine whether they are accepted or rejected.

At stage 64, if the round r that just ended is the first round, then EOR process 50 will evaluate whether the auction is done at stage 80. If the round r is not the first round, then the rollback phase at stage 66 is evaluated.

At stage 66, in an embodiment, the EOR process 50 can determine whether a bidder tried to reduce the quantity it bid on a particular product, and then allow that reduction provided it does not violate established auction rules. The general effect of a reduction in blocks bid on the overall demand can be determined. For example, if the reduced blocks on a particular product would allow the demand for that product to fall below a supply minimum (i.e., if the product becomes under-subscribed based on the established supply parameters), then some or all of the reduced blocks can be rejected and those blocks can be rolled back. In operation, in an embodiment, if multiple bidders reduce the quantity of their respective bids, the system can randomize the reduced bids (e.g., by bidder, or by identified product blocks) or otherwise select bids to reject only a portion of the bids to correct the under-subscription. Other initialized parameters can be used to initiate a rollback of the bids.

In general, there are two ways a bidder can reduce their bid on a product: 1) a switch, and 2) an eligibility reduction.

A switch is generally a reduction in the bidder's quantity bid on one product and an increase in the quantity bid on one or more other products because the bidder in effect has changed the subject of its bid. For example, if products in an auction are being auctioned as a series of blocks, a bidder may bid for 10 blocks for product A and 20 blocks for product B in one round, and then switch to bid for 5 blocks for product A and 25 blocks product B in the subsequent round. This switch of blocks from A to B reduces the number of blocks bid for product A.

A reduction in eligibility is generally when a bidder bids for X number of blocks across all products in one round, and then reduces its bid to (X-n) number of blocks across all products in the subsequent round.

A switch and an eligibility reduction generally can occur simultaneously. For example, a bidder may increase the number of blocks it bids on one or more products but reduce the total number of blocks it bids across all products.

In operation, a bidder does not need to identify whether their bid is a switch or an eligibility reduction. The bidder need only identify, for example, the number of blocks of the desired product or products. The EOR process 50 can determine how much a bidder reduces, or increases, their bid and then can determine whether the change can be treated as a switch or an eligibility reduction. The EOR process can calculate the effect of the collective bid information (i.e., the rolled-back bids and the non-rolled-back bids) in view of the auction parameters. If the collective bid information satisfies the auction parameter(s), then the rollback phase can be completed (i.e., some of the reduced bids can be allowed). The collective bid information can include partial rolled-back bids (i.e., bids which are rolled-back to values between the previous round and the current round). The collective bid information can be output (e.g., stored in memory, printed, displayed) to be used by the auction network 10.

Stages 68-76 represent elements for establishing priorities for accepting and rejecting changed bids in the rollback phase 66. Each of the stages 68-76 can be optional based on the nature of the auction and the corresponding products.

As an example, and not a limitation, an EOR process 50 can include stages 68, 70, 72, and 74, but exclude stage 76. Through stages 68, 70, 72, and 74, a rollback priority can be given to the bidders who switch their blocks. For example, to the extent a feasible solution can be maintained (i.e., a supply and/or demand parameters are satisfied), switching blocks can be allowed (i.e., the switched blocks will not be rolled-back). That is, blocks that reflect an eligibility reduction will be rolled-back before the switched blocks. The EOR process 50 can iterate through the bids to selectively roll back blocks based on the nature of a switch and/or the size of the eligibility reduction, and/or both.

As an example, and not a limitation, an EOR process 50 can include stage 76, but exclude stages 68, 70, 72, and 74. Stage 76 can be an optional step, and only eligibility reduction bids can be examined. This embodiment can typically occur for products with unique supply and demand structures, which can prohibit the use of switches in determining a feasible solution. Hence, only rollbacks based on eligibility reductions can be used.

At stage 78, block displacements and free eligibility blocks can be identified. In operation, the actions associated with displacement and free eligibility blocks are related to the way product prices can be changed in an auction. As an example, and not a limitation, the EOR process 50 can be configured to utilize single and multiple product price models. In an embodiment, a one-price approach can be used. For example, when a bid is rolled-back at stage 66, all of the blocks on a product can be priced at the previous round's price (i.e., a lower price in an ascending-price auction). In general, in an embodiment, the auction rules can allow a bidder to reduce the number of blocks that they have bid on a given product, if and only if the price of the product increases. This type of rule can help establish price/quantity relationships. That is, if there is more demand for a product than there is supply of the product, the price of the product can increase. In operation, when the price of a product is increased, the demand can increase (not usual), or the demand could remain steady, or the demand could fall. If the demand falls in response to the price increase such that the product is under-subscribed, then a rollback may be required.

In an embodiment, if the price on the product is set too high such that it causes under-subscription, both the quantities in the bids and the price can be rolled-back. That is, the price for all bids placed in the round are rolled back to the pre-increase price, and the switch and/or eligibility reductions are handled as described above. As a result, the price for the product is maintained at the value of the previous round.

In another embodiment, a multi-price approach can be used. For example, if the price on the product is set too high such that it causes under-subscription, a two-price approach can be used. That is, the prices associated with blocks of products are maintained based on when the bid was entered. For example, if the price of the product is increased and new bids are entered at that price, while the quantity of other bids are reduced such that the product is under-subscribed, then the price for the blocks bid at the new higher price is not rolled back. The price of the blocks that left the product (i.e., blocks that caused under-subscription) is the price at which the blocks were bid previously (i.e., the lower price). As a result, in general the blocks bid on the product (i.e., the blocks in the product's bid stack) may include blocks at the higher price and blocks at the lower price.

Accordingly, at stage 78, the EOR process 50 can determine whether the bid stack which includes blocks of a product at two prices has sufficient new blocks bid at the higher price. If the product has sufficient blocks, then to the extent it is possible with the auction parameters, the process 50 can displace lower price blocks with the higher price blocks to achieve the price/quantity relationships. The lower price blocks that are displaced become free eligibility blocks, which can be used to bid on any product in the subsequent round, but will be removed from the auction thereafter if not bid on a product. That is, the bidder has one round to bid any free eligibility blocks it has on any product. Free eligibility blocks contribute towards the bidder's overall eligibility for one round.

At stage 80, a determination is made based on the auction parameters and the price/quantity relationships as to whether or not the auction is done.

At stage 82, if the auction is not over, then new prices can be established for products that are over-subscribed, and the bidder eligibility (i.e., the maximum number of block the bidder can bid on) for the next round can be determined. For example, in an embodiment, the auction rules may require that the number of blocks a bidder can bid on can be no higher than the number of blocks bid on in the round that just ended. Other constraints may also be determined. Bid constraints can be provided to the bidders via the network 10, and may be programmatically implemented as validation rules during the computer implemented bidding process 56.

At stage 84, if the auction is completed, then the winning bidders, prices and associated blocks are determined. Results can be reported over the network 10 and proscribed in the auction rules.

Other embodiments are within the scope and spirit of the invention. For example, due to the nature of software, functions described above can be implemented using software, hardware, firmware, hardwiring, or combinations of any of these. Features implementing functions may also be physically located at various positions, including being distributed such that portions of functions are implemented at different physical locations.

Further, while the description above refers to the invention, the description may include more than one invention.

What is claimed is:

1. A system for conducting multi-round auctions, comprising;
a plurality of remote computer stations operably connected to a network and configured to receive bid information from a plurality of bidders, wherein the bid information is received in successive rounds;
a Web server component operable to receive and store the bid information from the plurality of remote computer stations, receive and store auction parameters, and including application software configured to evaluate the bid information at the end of each of the successive rounds, wherein evaluating the bid information includes:
evaluating the received bid information to determine if any of the plurality of bidders changed their bid information in the current round just ended as compared to the previous round;
rolling back the bid information received from at least one bidder if their bid information changed between the current and the previous rounds, wherein the rolled-back bid information equals at least a part of the bid information provided by the bidder in the previous round;
calculating a collective bid information as a function of the current bid information received from bidders whose individual bid information was not rolled back and the rolled-backed bid information from the bidders whose individual bids information was rolled back;
determining whether the collective bid information satisfies at least one auction parameter; and
outputting the collective bid information if the at least one auction parameter is satisfied.

2. The system of claim 1 wherein the bid information and the auction parameters include price and quantity information.

3. The system of claim 2 wherein evaluating bid information includes increasing or decreasing the prices in the auction parameters if the quantities in the collective bid information are greater or less than the quantities in the auction parameters.

4. The system of claim 1 wherein the auction parameters include demand parameters.

5. The system of claim 1 wherein the auction parameters include supply parameters.

6. The system of claim 1 wherein rolling back the bid information includes rolling back only bid information that changed based on either eligibility reductions or switches individually.

7. The system of claim 1 wherein rolling back the bid information includes rolling back bid information that changed based on eligibility reduction, and then rolling back bid information that changed based on switches.

8. The system of claim 1 wherein rolling back the bid information includes rolling back bid information that changed based on switches, and then rolling back bid information that changed based on eligibility reduction.

9. A computer implemented multi-round auction system to provide feasible solutions to satisfy supply, demand and price constraints, comprising:
a storage device;
a processor programmed to:
receive bids from a plurality of bidders in a series of sequential rounds,
compare the plurality of bids received in a current round with an auction parameter to determine if a constraint is satisfied,
if the constraint is not satisfied, then determine which bids changed between the current round and the previous round, and iteratively roll back changed bids until the constraint is satisfied, and
store the bids on the storage device.

10. The computer implemented multi-round auction system of claim 9 wherein the bids include price information.

11. The computer implemented multi-round auction system of claim 10 wherein rolling back the changed bids includes decreasing the value of the price information in the bids.

12. The computer implemented multi-round auction system of claim 10 wherein rolling back the changed bids includes increasing the value of the price information in the bids.

13. The computer implemented multi-round auction system of claim 9 wherein rolling back the changed bids includes setting a value of the bid received from a bidder in the current round to be equal to the value of the bid received from the bidder in the previous round.

14. The computer implemented multi-round auction system of claim 9 wherein the bid received from a bidder in the previous round includes a first value, and the bid received from the bidder in the current round includes a second value, and rolling back the changed bids includes setting the bid received from the bidder in the current round to a third value, wherein the third value is within a range of values between the first and second values.

15. A computer-readable medium having computer-executable instructions for managing multi-round auctions over a network, comprising:
storing a plurality of auction parameters;
storing information associated with a plurality of blocks;
setting a first price value for each block in the plurality of blocks;
receiving first bids from a plurality of bidders over the network, wherein the first bids include price and quantity information;
determining a second price value as a function of the first bids and at least one auction parameter;
storing the second price value for each block in the plurality of blocks;
receiving subsequent bids from the plurality of bidders over the network, wherein the subsequent bids include price and quantity information;
rolling back the price information in the subsequent bids submitted by at least one of the plurality of bidders to the value of the price information in the bidder's first bid;
determining if the multi-round auction is complete; and
outputting an auction result.

16. The computer-readable medium of claim 15 wherein managing multi-round auctions over a network includes rolling back the quantity information in the subsequent bids submitted by at least one of the plurality of bidders to the value of the quantity information in the bidder's first bid.

17. The computer-readable medium of claim 15 wherein managing multi-round auctions over a network includes rolling back the price information in the subsequent bids submitted by at least one of the plurality of bidders to a value between the price information in the bidder's first and subsequent bids.

18. The computer-readable medium of claim 16 wherein managing multi-round auctions over a network includes rolling back the quantity information in the subsequent bids submitted by at least one of the plurality of bidders to a value between the quantity information in the bidder's first and subsequent bids.

19. The computer-readable medium of claim 15 wherein managing multi-round auctions over a network includes storing the first price information associated with each block in a first subset of the plurality of blocks, and storing the second price information associated with each block in a second subset of the plurality of blocks.

20. The computer-readable medium of claim 15 wherein managing multi-round auctions over a network includes storing free eligibility blocks.
